(19) United States
(12) Patent Application Publication
(10) Pub. No.: US 2026/0341986 A1
(43) Pub. Date: Oct. 29, 2026

(54) CONNECTION ARRANGEMENT WITH FLAT CONDUCTOR CONNECTION ELEMENT AND AN ELECTRICAL LINE CONNECTION

(71) Applicants: SAINT-GOBAIN GLASS FRANCE, COURBEVOIE (FR); FEW Fahrzeugelektrik Werk GmbH & Co. KG, ZWENKAU (DE)

(72) Inventors: Bernhard REUL, HERZOGENRATH (DE); Francois HERMANGE, HERZOGENRATH (DE); Volker LAMMERTS, ZWENKAU (DE); Peter Thomas KRABS, ZWENKAU (DE)

(21) Appl. No.: 18/880,131

(22) PCT Filed: Jul. 5, 2023
(86) PCT No.: PCT/EP2023/068529

§ 371 Date: Dec. 30, 2024

(30) Foreign Application Priority Data
Jul. 20, 2022 (EP) 22185919.2

(51) Int. Cl. H01R 12/63; H01R 4/70; H01R 43/00

(52) U.S. Cl. CPC H01R 12/63; H01R 4/70; H01R 43/005; H01R 2201/26

(57) ABSTRACT

A connection arrangement includes a glazing unit with an electrical component and a flat conductor connection element, wherein the flat conductor connection element is guided with a second connection region between the two panes out of the glazing unit, wherein an electrical conductor track of the flat conductor connection element is provided for electrically contacting the electrical component, wherein a sealant is arranged at the first end and/or at the second end of the flat conductor connection element, and wherein the flat conductor connection element has at least one recess in the region of an outer edge, and the recess is filled with an adhesive layer, an adhesive tape, or a thermoplastic layer.

The invention relates to a connection arrangement with a flat conductor connection element and an electrical line connection.

In the case of composite panes that have at least two rigid panes and one intermediate layer planarly connecting them, as well as electrical components, such line connections usually comprise a transition from a flat conductor connection element to a round cable. The electrical components installed in a composite pane can be heating components, antenna elements, and functional elements which are installed flat and can be electrically contacted via so-called busbars. Composite panes equipped in this way are used as glazing units in automobiles as a windshield, rear and side pane, or also in the construction sector.

The functional element is embedded in the composite pane. During the production of the composite pane, the functional element is cut in the desired size and shape and inserted between films of the intermediate layer. Typical intermediate layers are polyvinyl butyral films which, in addition to their adhesive properties, have high toughness and high acoustic damping. The intermediate layer prevents the disintegration of the composite pane during damage. The composite pane forms only cracks, but remains dimensionally stable.

Such composite panes as glazing elements contain the functional element, which typically comprises an active layer between two planar electrodes. The optical properties of the active layer can be changed by a voltage applied to the planar electrodes. Electrochromic functional elements, known, for example, from US 20120026573 A1 are an example of this. SPD functional elements (Suspended Particle Device) or PDLC functional elements (Polymer Dispersed Liquid Crystal), known, for example, from EP 0876608 B1 and WO 2011033313A1 , are another example.

In order to guide a flexible line connection as an outer connection out of the interior of the composite pane, flat cables that consist of at least one thin carrier substrate and at least one metallic conductor track (conductor strip) are usually used. In addition, a cover layer may be provided so that the flat conductor overall forms a three-layer laminate. The flat conductors are soldered to connection faces close to the edge of the composite pane and guided only over this edge outwards, where they are connected to a round cable at a distance from the edge.

In practice, flat conductor connection elements that have a plurality of electrical conductor tracks are used for contacting. The electrical conductor tracks are very thin, with thicknesses, for example, in the range of 0.03 mm to 0.1 mm, and consist, for example, of copper, which has proven successful, since it has good electrical conductivity and good processability. At the same time, the material costs are relatively low.

Such flat conductor connection elements have a first connection region for contacting an electrical component, e.g., a functional element, within the composite pane. At the other end, the flat conductor connection element is guided out of the composite pane. Since it cannot be avoided that moisture penetrates into the composite pane along the flat cable, interference can arise at the contact point due to sealing defects. A second connection region is located at the end, guided out of the composite pane, of the flat conductor connection element. The second connection region is provided for contacting with a connection cable (round cable). The connection cable typically has connecting pieces that are pre-fabricated on one side, such as plugs or sockets, with which the round cable can be connected to external electrical devices.

However, the transition region of the flat conductor connection element to the round cable is sensitive to dust, dirt, and moisture and is therefore embedded in a casing, housing, or encapsulation made of plastic. Since it cannot be avoided that moisture penetrates into the encapsulation, interferences at the connecting point can also arise here due to sealing defects.

JP 2003 257597 A (English abstract) discloses a flat heating element which is arranged via a conductive band on an end part of a wire connected to a power supply.

GB 2 539 834 A describes an electrical connection which electrically connects a flat cable and a cable, wherein the electrical connection comprises a first seal, an optional second seal, and an enclosure. The enclosure surrounds at least the first seal and the electrical contact. In this embodiment too, it cannot be avoided that interferences arise at the connecting point to the round cable or within a composite pane.

The object of the present invention is to provide an improved electrical line connection which ensures reliable and permanently watertight sealing at the contact point in the composite pane and/or at the transition region of flat conductor connection element to connection cable.

This object is achieved by the invention specified in the independent claims. Preferred embodiments are apparent from the dependent claims.

The connection arrangement according to the invention comprises a glazing unit with an electrical component and a flat conductor connection element which has at least one electrical conductor track and a cover film for electrically insulating the at least one conductor track. The flat conductor connection element furthermore has a first connection region at a first end and a second connection region at a second end. The first connection region is arranged between two panes of the glazing unit. Furthermore, the flat conductor connection element is guided with the second connection region between the two panes out of the glazing unit. The electrical conductor track is provided for electrically contacting the electrical component of the glazing unit. A sealant is arranged at the first end and/or at the second end of the flat conductor connection element, wherein the sealant is provided for blocking water capillaries forming on the flat conductor connection element. Particularly in the installed state, water capillaries can form along the cover films and are prevented by the sealant arranged on the flat conductor connection element. Such an arrangement of the sealant (seals) ensures that the ingress of water and moisture into a glazing unit or an encapsulation is prevented.

The sealant may be an adhesive tape that has an adhesive layer and is provided for connecting the flat conductor connection element to the glazing unit or a plastic component so that a high-density and resistant connection between the flat conductor connection element and a glazing unit or an encapsulation can exist at the respective end of the flat conductor connection element in the connection region.

In an advantageous embodiment, the sealant is designed as a double-sided adhesive tape. In particular, the adhesive tape may be an acrylic adhesive tape. In addition, the adhesive tape may be transparent. The material thickness of the adhesive tape can have a thickness of 25 μm up to 2 mm, preferably 100 μm up to 150 μm, and particularly preferably 130 μm [micrometers]. The adhesive tape can be arranged on two sides of the flat conductor connection element. The adhesive tape can be connected planarly via the one adhesive layer to the cover film of the flat conductor connection element. The adhesion by the adhesive tape advantageously supports the adhesion of the encapsulation to the flat conductor connection element so that the connection between the encapsulation and the flat conductor connection element is very dense and stable.

A particularly advantageous embodiment of the adhesive tape provides that the adhesive tape project beyond an outer edge of the flat conductor connection element. For this purpose, the adhesive tape can be wider than the flat conductor connection element. In this case, the adhesive tape extends beyond an outer edge of the cover film of the flat conductor connection element. The adhesive tape thus acts as a capillary barrier. This embodiment is particularly advantageous, since it is simple to produce.

In other words, the adhesive tape has, at least in portions, an edge region which is located between a lateral edge of the adhesive tape at a distance perpendicular to an outer edge of the flat conductor connection element. The edge region of the adhesive tape is preferably formed along the peripheral edge of the cover film, wherein the width of the edge region either is constant or can vary. The width of the edge region can be up to 1.5 mm [millimeters]. The adhesive tape thus acts as an edge seal at the flat conductor connection element.

The flat conductor connection element has at least one recess in the region of the outer edge—in particular, in the cover film—wherein the recess may be open to the outer edge. Preferably, the recesses are arranged on an insulating edge region of the flat conductor connection element. The recess can be punched out of the cover film of the flat conductor connection element. Furthermore, the at least one recess can be arcuate or rectangular. Such a recess can taper from the outer edge in the direction of the conductor track. The recess can be filled with the adhesive layer, the adhesive tape, and/or a thermoplastic layer—in particular, an intermediate layer—so that the ingress of water by capillary action along the outer edge is prevented. The at least one recess thus acts as an additional capillary barrier.

The cover film has a material thickness of 25 μm up to 50 μm. Such thicknesses are particularly suitable for achieving sufficient insulation of the at least one conductor track when the flat conductor connection element is used. Such thin, flat conductor connection elements are particularly flexible and can, for example, easily be laminated into and guided out of a glazing unit designed as a composite pane.

The first cover film preferably contains polyimide (PI) or polyester, and particularly preferably polyethylene terephthalate (PET) or polyethylene naphthalate (PEN), or consists thereof. The cover film may also consist of an electrically-insulating lacquer, and preferably a polymer lacquer. The cover films may also comprise or consist of thermoplastic plastics and elastomers, such as polyamide, polyoxymethylene, polybutylene terephthalate, or ethylene propylene diene rubber. Alternatively, potting materials, such as acrylate or epoxy resin systems, may be used as cover films. Such cover films are cost-effective and simplify the production process.

The flat conductor connection element (also called flat ribbon cable or flat conductor) comprises at least one electrical conductor track which is applied to the cover film as a carrier substrate made of plastic and which is also covered with the cover film as a cover layer. The cover film forms an insulation sheath which encloses the electrical conductor track. The flat conductor connection element, which is in particular flexible and/or bendable, serves for electrical connection to an electrical component, e.g., a functional element or a planar electrode. The flexible flat conductor connection element is a flat body with two opposite sides and can optionally be brought into a planar or curved shape. In the planar (i.e., non-curved) state, the flat conductor connection element is arranged in a plane. The flat conductor connection element is generally elongated and has the two ends along its extension direction. The flat conductor connection element can also be provided with a plurality of electrical conductor tracks, which in particular run parallel. Preferably, the flat conductor connection element may have up to 32, and particularly preferably 8 to 10, conductor tracks. The conductor tracks are arranged in a common plane. Each conductor track can have a rectangular cross-section. The flat conductor connection element is an elongated electrical component with several electrical conductor tracks, the width of the component being significantly greater than the thickness. The flat conductor connection element is so thin (i.e., the thickness is so small) that it is flexible and bendable. Its width can be 0.1 mm to 100 mm.

Furthermore, the flat conductor connection element comprises at least two connection regions with contact points of the conductor tracks on the two ends, opposite in the extension direction, of the flat conductor connection element. The two connection regions of the flat conductor connection element serve for electrically contacting the conductor tracks, for which purpose the cover film, i.e., carrier layer and/or insulation layer, is not present or removed at least at the contact points so that the conductor tracks are accessible.

The electrical conductor tracks are arranged so as to lie, at least in portions, next to one another and/or one above the other. In a further, advantageous embodiment of the invention, at least two electrical conductor tracks are arranged one above the other in at least two, and preferably in exactly two or exactly three or exactly four, planes. “One above the other” here means with respect to the extension plane of the flat conductor connection element, i.e., with respect to the plane that is spanned by the two larger dimensions (length and width) of the flat conductor connection element. Advantageously, at least two conductor tracks are in each case arranged congruently in the projection orthogonal to the extension plane. Alternatively, the conductor track can also be designed to be larger in one plane and, essentially, partially or completely occupy the plane within the flat conductor connection element—preferably minus an insulating edge region. This increases the current-carrying capacity of this conductor track.

Each electrical conductor track can be electrically contacted to two contact points spaced apart from one another along the conductor track. The contact points are regions of the conductor tracks at which electrical contact is possible. In the simplest embodiment, they are accessible regions of the electrical conductor tracks. In this case, it may be necessary and expedient to provide a separate line connection for each pole, so that a conductor track of the flat conductor connection element is in each case provided for connection to a conductor of a cable.

The conductor tracks are applied by means of printing methods. Alternatively, the electrical conductor tracks are prefabricated as metal strips made of metal foil and laminated on both sides with a plastic material. In both cases, the electrical conductor tracks are mechanically stabilized and embedded in an insulation sheath consisting of the cover film, so that they are electrically insulated from the external environment.

The metal foil can contain or consists of a copper foil, an aluminum foil, a stainless-steel foil, a tin foil, a gold foil, or a silver foil. The metal foil can also contain or consist of alloys with the metals mentioned. The metal foil can advantageously be tin-plated in portions or completely tin-plated. This is particularly advantageous in order to achieve good solderability with simultaneous corrosion protection.

In an advantageous embodiment of the flat conductor connection element according to the invention, the at least one conductor track has a thickness of 35 μm to 100 μm, and preferably of 50 μm to 75 μm. According to one embodiment, the electrical conductor tracks have a width of 0.05 mm to 40 mm, preferably of 1 mm to 20 mm, and in particular of 2 mm to 5 mm. Such widths are particularly suitable for achieving sufficient current-carrying capacity in conjunction with the thicknesses mentioned above.

The invention furthermore relates to a connection arrangement comprising a glazing unit with an electrical component—in particular, a functional element—and a flat conductor connection element according to the invention. The functional element can be a PDLC functional element.

In a further embodiment of the connection arrangement according to the invention, the at least one conductor track of the flat conductor connection element can be electrically-conductively connected to the electrical component via a soldered connection. Alternatively, the electrical connection can be produced via an adhesive connection by means of an electrically-conductive adhesive.

The glazing unit comprises a first pane and second pane as well as two intermediate layers between the first pane and the second pane. The functional element is arranged between the two intermediate layers, wherein the flat conductor connection element is electrically-conductively connected at one end to a planar electrode of the functional element.

The glazing unit as a composite pane comprises a first pane and a second pane, which are preferably made of glass, and particularly preferably of soda-lime glass, as is customary for window panes. However, the panes may also be manufactured from other types of glass, e.g., quartz glass, borosilicate glass, or aluminosilicate glass, or from rigid, clear plastics, e.g., polycarbonate or polymethyl methacrylate. The panes may be clear, or also tinted or colored. If the glazing unit is used as a windshield, it should have sufficient light transmission in the central viewing area-preferably at least 70% in the main field of view A according to ECE-R43. The first pane and the second pane can also be referred to as outer and inner panes.

The first pane, the second pane, and/or the intermediate layer can have further, suitable coatings known per se, e.g., anti-reflective coatings, non-stick coatings, anti-scratch coatings, photocatalytic coatings or sun protection coatings, or low-e coatings.

The thickness of the first pane and of the second pane can vary widely, and thus be adapted to the requirements in the individual case. The first pane and the second pane advantageously have standard thicknesses of 0.7 mm to 25 mm—preferably 1.4 mm to 2.5 mm for vehicle glass and preferably 4 mm to 25 mm for furniture, devices, and buildings, and in particular for electric heaters. The size of the panes can vary widely and depends upon the size of the use according to the invention. The first and the second panes have surfaces of 200 cm² up to 20 m², as is usual, for example, in vehicle assembly and the architectural sector.

The functional element has electrically-controllable optical properties and comprises a first carrier film, a first planar electrode, an active layer, a second planar electrode, and a second carrier film planarly arranged one above the other. The carrier films and the planar electrodes are preferably transparent. According to one embodiment of the glazing unit according to the invention, the functional element is a so-called PDLC (Polymer Dispersed Liquid Crystal) functional element.

The active layer has the variable optical properties which can be controlled by an electrical voltage applied to the active layer. In the context of the invention, electrically-controllable optical properties are understood to mean those properties that are continuously controllable, but equally also those that can be switched between two or more discrete states. The optical properties relate in particular to the light transmission and/or the scattering behavior.

The first and second carrier films are in particular polymeric or thermoplastic films. The carrier films contain, in particular, a thermoplastic material, or consist thereof. The thermoplastic material may be a thermoplastic polymer or a mixture of two or more thermoplastic polymers. In addition to the thermoplastic material, the carrier film may also contain additives, e.g., plasticizers. The thermoplastic material of the carrier films is preferably polyethylene terephthalate (PET), as is customary in commercially available functional elements.

The thermoplastic material of the carrier film may also contain or consist of mixtures of PET with other thermoplastic polymers and/or copolymers of PET. The thermoplastic material of the carrier film may, for example, also contain or consist of PU, polypropylene, polycarbonate, polymethyl methacrylate, polyacrylate, polyvinyl chloride, polyacetate resin, fluorinated ethylene propylene, polyvinyl fluoride, and/or ethylene tetrafluoroethylene. The thickness of each carrier film is preferably in the range of 0.03 mm to 0.4 mm, and more preferably 0.04 mm to 0.2 mm.

The planar electrodes of the functional element comprise an electrically-conductive coating on the carrier film. The side of the carrier film with the electrically-conductive coating then faces the active layer.

In a further, preferred embodiment, the functional element is a PNLC or SPD functional element. In the case of an SPD functional element, the active layer contains suspended particles, wherein the absorption of light through the active layer can be changed by applying a voltage to the planar electrodes. PNLC functional elements (PNLC=Polymer Network Liquid Crystal) contain an active layer in which the liquid crystals are embedded in a polymer network, wherein the mode of operation is otherwise analogous to that of PDLC functional elements (Polymer Dispersed Liquid Crystal).

The planar electrodes are provided to be electrically connected to an external voltage source. The contact of the planar electrode preferably takes place by (ultrasonic) soldering, crimping, or adhesive bonding. For this purpose, a conductive material—in particular, a paste—or a soldering contact is applied to at least one of the planar electrodes. The paste contains silver or a silver-containing alloy. The conductive material is connected as a so-called busbar, e.g., strips of the electrically-conductive material or electrically-conductive prints, to the planar electrodes. The planar electrodes can be electrically contacted by means of a respective busbar.

In an alternative embodiment of the busbars, thin and narrow metal foil strips or metal wires that preferably contain copper and/or aluminum, are used; in particular, copper foil strips of a thickness of approx. 50 μm are used. The width of the copper foil strips is preferably 1 mm to 10 mm. When the functional element is further processed, the metal foil strips or metal wires are placed onto the planar electrode in a composite of thermoplastic layers. In the later autoclaving process, a reliable electrical contact between the busbars and the coating is achieved by the action of heat and pressure. The electrical contact between the planar electrode and the busbar can alternatively be produced by soldering, placing, or gluing with an electrically-conductive adhesive.

The busbars are attached to the planar electrodes by the carrier film, a planar electrode, and the active layer being recessed so that the respective other planar electrode with the associated carrier film protrudes. This may preferably be carried out along an edge region of the respective side of the functional element. A busbar can then be attached to the protruding planar electrode, or the flat conductor connection element can be contacted directly with the planar electrode. A further busbar is attached to the other planar electrode in a corresponding manner on the opposite side of the respective functional element.

In an advantageous embodiment, the functional element is a PDLC functional element—in particular, one that switches at least one region of a glazing unit from a transparent into an opaque state, and vice versa. The active layer of a PDLC functional element contains liquid crystals which are embedded in a polymer matrix. The thickness of the functional element is, for example, 0.09 mm to 1 mm.

Furthermore, the invention relates to an electrical line connection with a cross-sectional transition region from the flat conductor connection element, comprising a conductor track, of the connection arrangement according to the invention to a cable—in particular, a round cable—comprising at least one electrical conductor. In the cross-sectional transition region, an electrical connection is provided between the conductor track of the flat conductor connection element and the conductor of the cable, as well as an encapsulation which serves as a plastic component for electrically insulating the electrical connection. An adhesive tape as a sealant is preferably applied to the flat conductor connection element in the region of the encapsulation. In a simple manner, the electrical line connection according to the invention has a permanently effective protection against moisture.

In a further embodiment of the electrical line connection according to the invention, the conductor track of the flat conductor connection element can be electrically-conductively connected to the conductor of the (round) cable via a soldered connection. Alternatively, the electrical connection can be produced via an adhesive connection by means of an electrically-conductive adhesive. The electrically-conductive adhesive contains at least one electrically-conductive material—preferably metallic material, e.g., silver, gold, or aluminum. It is also possible for the electrically-conductive adhesive to contain a non-metallic electrical material, e.g., graphite or carbon. The at least one electrically-conductive material is introduced into a non-electrically-conductive adhesive matrix, e.g., epoxy resin. The at least one electrically-conductive material is contained in the adhesive in such an amount that a desired current-carrying capacity is achieved. Preferably, the at least one electrically-conductive material is contained at a mass fraction of at least 70% in the adhesive.

In a further, preferred embodiment of the electrical line connection according to the invention, the encapsulation has a plastic as an insulating material. In this case, the encapsulation can consist of an appropriately solid plastic, e.g., polyimide (PI) or PA66 in conjunction with glass fibers. The encapsulation can be produced, for example, in an injection-molding method, wherein the encapsulation is designed as a rectangular or round housing.

The cable has a connecting element—in particular, a socket or plug—on its end facing away from the encapsulation. In addition to an electrically-conductive conductor (inner conductor, or also lead, wire, or core), the cable may comprise an insulating, and preferably polymeric, cable jacket, wherein the insulating cable jacket is preferably in each case removed in the end region of the cable in order to enable an electrically-conductive connection between the conductor of the cable and the flat conductor connection element or a connecting element. The electrically-conductive conductor of the cable may, for example, contain copper, aluminum, and/or silver, or alloys or mixtures thereof. The cable has a preferably round or oval cross-section of, for example, 0.3 mm² to 6 mm².

The invention furthermore extends to a vehicle having the connection arrangement according to the invention.

Furthermore, the invention extends to the use of the connection arrangement according to the invention in a vehicle—in particular, a motor vehicle—for traffic on land, on water, or in the air.

The various embodiments of the invention may be implemented individually or in any combinations. In particular, the features mentioned above and to be explained below can be used not only in the specified combinations, but also in other combinations or alone without departing from the scope of the present invention.

In the following, the invention is explained in more detail with reference to figures and exemplary embodiments. The figures are schematic representations and not to scale. The figures do not limit the invention in any way.

Shown are:

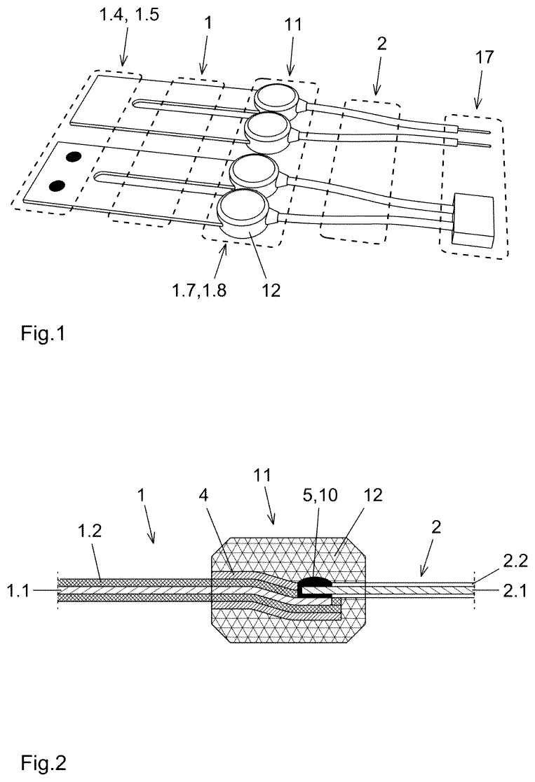

FIG. 1 a schematic plan view of an embodiment of the line connection according to the invention with a flat conductor connection element,

FIG. 2 a cross-sectional view of the line connection according to the invention,

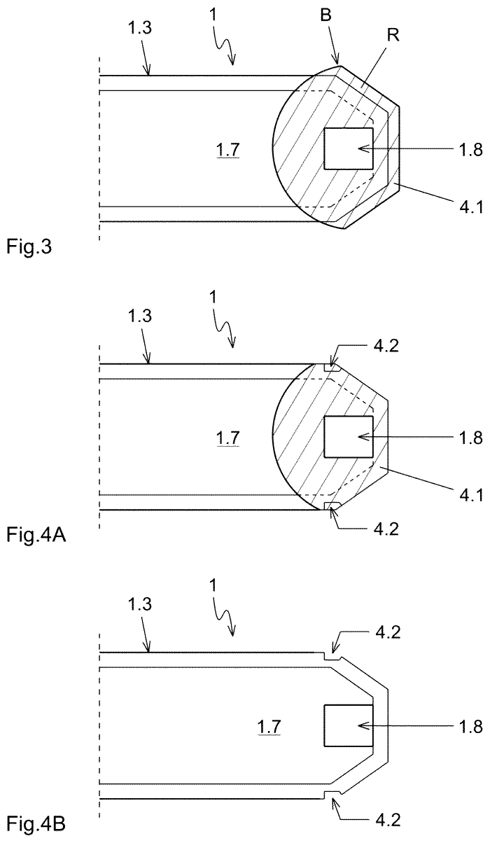

FIG. 3 a plan view of a first embodiment of an end of the flat conductor connection element according to the invention,

FIGS. 4A and 4B a second embodiment of an end of the flat conductor connection element according to the invention,

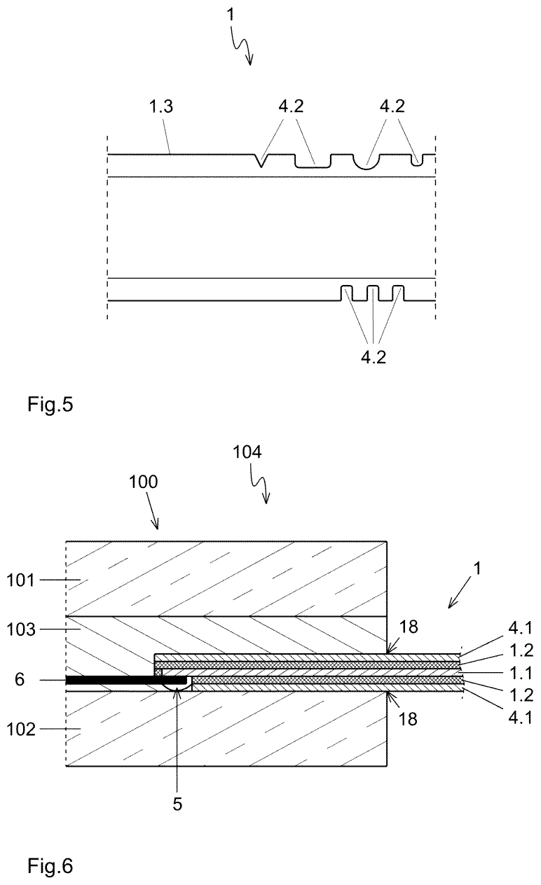

FIG. 5 a schematic plan view of a flat conductor connection element according to the invention with recesses,

FIG. 6 a cross-sectional view of a connection arrangement according to the invention,

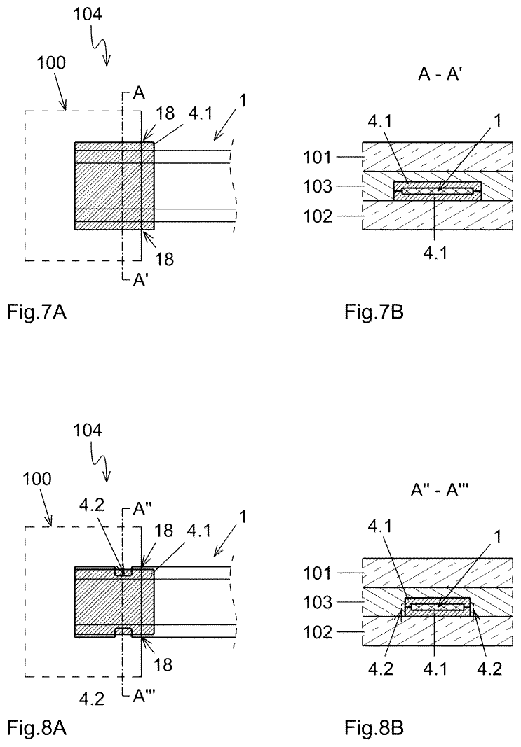

FIGS. 7A and 7B a first embodiment of the connection arrangement according to the invention, and

FIGS. 8A and 8B a second embodiment of the connection arrangement according to the invention.

Specifications with numerical values are generally not to be understood as exact values, but also include a tolerance of +/−1% up to +/−10%.

FIG. 1 shows a schematic plan view of an embodiment of the line connection according to the invention with a flat conductor connection element 1. The flat conductor connection element 1 comprises a conductor track 1.1, a cover film 1.2, and a sealant 4 (FIG. 2). At its two ends 1.4 and 1.7 opposite in the extension direction, the flat conductor connection element 1 in each case has a first connection region 1.5 and a second connection region 1.8. The longest dimension (length) of the flat conductor connection element 1 defines its extension direction. The connection regions 1.5 and 1.8 of the flat conductor connection element 1 serve for electrically contacting the conductor tracks 1.1. The cover film 1.2 is at least partially removed at the contact points so that the conductor track 1.1 is accessible.

At a first end 1.4, the flat conductor connection element 1 has the first connection region 1.5. At a second end 1.7, the flat conductor connection element 1 has the second connection region 1.8, which serves for an outer connection of the conductor track 1.1—here, for example, for soldering the conductor track 1.1 to a cable 2 designed as a round cable. The second connection region 1.8 is located within a plastic component which is formed as an encapsulation 12 and into which one end of the cable 2 is inserted. The encapsulation 12 encloses a cross-sectional transition region 11 which serves as a transition from the flat conductor connection element 1 according to the invention to the cable 2 comprising an electrical conductor 2.1. A plug or socket 17, which can be connected to external electronics (e.g., control electronics), is attached to the other end of the cable 2.

The encapsulation 12 can be produced, for example, in an injection-molding or 3-D printing method. The encapsulation 12 consists, for example, of a solid plastic, e.g., polyamide (PA) and/or polyimide (PI), PBT, PA611, PA12, PA6, or PA66 in conjunction with glass fibers (up to 50%). The encapsulation 12 also serves to mechanically protect the electrical contact between the flat conductor connection element 1 and the cable 2.

The conductor track 1.1 has a rectangular cross-section. The conductor track 1.1 is enclosed by an insulation sheath consisting of the cover film 1.2. For this purpose, the cover film 1.2 is glued to the conductor track 1.1. The flat conductor connection element 1 can comprise several conductor tracks 1.1. The conductor tracks 1.1 are then arranged next to one another and/or lying one above the other. The electrical conductor tracks 1.1 consist, for example, of a thin copper, silver, tin, or gold film. The films can additionally be coated, e.g., silver-plated, gold-plated, or tin-plated. The thickness of the films is, for example, 35 μm, 50 μm, 75 μm, or 100 μm. The width of the conductor track can also be 1 mm up to 22 mm.

For the material of the cover film 1.2, films made of polyimide, and preferably black or yellow polyimide films (e.g., PI-MTB/MBC), e.g., of a thickness of 25 μm, are particularly suitable. Alternatively, polymer films made of PEN, and preferably of white PEN, e.g., of a thickness of 25 μm, may be used.

The cover film 1.2 is glued via an adhesive layer to the conductor track 1.1 and, at the protruding edges, to the cover film 1.2 of the opposite side. The adhesive layers of the cover film 1.2 may contain or consist of epoxy adhesives or thermoplastic adhesives, for example. Typical thicknesses of the adhesive films are 25 μm to 35 μm. The adhesives may be transparent or colored, e.g., black. Only the first connection region 1.5 and the second connection region 1.8 are formed without a cover film. This can be achieved, for example, by a window technique during production or by subsequent removal of the cover film 1.2—for example, by laser ablation.

FIG. 2 shows an embodiment of an electrical line connection 10 according to the invention with the cross-sectional transition region 11 in a cross-sectional view. The flat conductor connection element 1 comprises the conductor track 1.1, the first cover film 1.2, and the sealant 4. The sealant 4 is arranged at the second end 1.7 on the cover film 1.2 within the encapsulation 12.

The cross-sectional transition region 11 comprises an electrical connection between the conductor track 1.1 of the flat conductor connection element 1 and the conductor 2.1 of the (round) cable 2. The cross-sectional transition region 11 has an encapsulation 12. The encapsulation 12 serves to insulate the electrical contact (e.g., soldering) between the flat conductor connection element 1 and the cable 2.

In addition to an electrically-conductive conductor 2.1, the cable 2 also comprises an insulating, polymeric cable jacket 2.2, wherein the insulating cable jacket 2.2 is removed in the end region of the cable in order to enable an electrically-conductive connection between the conductor 2.1 of the (round) cable 2 and the conductor track 1.1. The electrically-conductive conductor 2.1 of the (round) cable 2 contains copper. The cable 2 has a round or oval cross-section, the cross-sectional area of which is, for example, 5 mm².

The cable 2 can in principle be any connection cable known to the person skilled in the art for electrically contacting a functional element and suitable for being connected to a connecting element (also called crimp contact) by crimping or clamping. The conductor 2.1 of the round cable 2 is stripped at its end pointing to the flat conductor connection element 1 and is fixedly connected to the conductor track 1.1 via a soldered connection 5.

FIG. 3 shows a plan view of a first embodiment of the second end 1.7 of the flat conductor connection element 1 according to the invention. The second end 1.7 has a sealant 4 formed as an adhesive tape 4.1. The adhesive tape 4.1 forms, at least in portions, an edge region B which is located between a lateral edge R of the adhesive tape 4.1 at a distance perpendicular to an outer edge 1.3 of the flat conductor connection element 1. The edge region B of the adhesive tape 4.1 is formed along the peripheral edge of the cover film 1.2, wherein the width of the edge region B is constant. The adhesive tape 4.1 projects beyond the outer edge 1.3 of the flat conductor connection element 1. For this purpose, the adhesive tape 4.1 has a greater width than the width of the flat conductor connection element 1. The second longest dimension of the flat conductor connection element 1 defines its width.

In particular, the adhesive tape 4.1 extends beyond the outer edge 1.3 of the cover film 1.2 of the flat conductor connection element 1, which is covered by the encapsulation 12. The adhesive tape 4.1 thus acts as a capillary barrier. The adhesive tape 4.1 can be arranged on two opposite sides of the flat conductor connection element 1.

FIG. 4A shows a second embodiment of the second end 1.7 of the flat conductor connection element 1 according to the invention. In contrast to FIG. 3, the adhesive tape 4.1 does not project beyond the outer edge 1.3, but is largely flush with it. Unlike in FIG. 3, the cover film 1.2 has two recess 4.2. The recesses 4.2 are each covered by the adhesive tape 4.1.

The recesses 4.2 are located in the region of the outer edge 1.3, and in particular in the cover film 1.2. They are rectangular in design. Alternatively, the recesses may be arcuate. The recesses 4.2 extend from the outer edge 1.3 in the direction of the conductor track. The two recesses 4.2 are at least partially filled with the adhesive layer of the adhesive tape 4.1 so that the ingress of water by capillary action along the outer edge 1.3 is effectively prevented. The recesses 4.2 thus act as a further capillary barrier.

FIG. 4B shows the second embodiment of the second end 1.7 free of the adhesive tape 4.1. The second end 1.7 of the flat conductor connection element 1 is shown without the adhesive tape 4.1, as a result of which the recess 4.2 can be clearly seen. The recesses 4.2 are open to the outer edge. The recesses are arranged on an insulating edge region of the flat conductor connection element 1. The recesses 4.2 extend from the outer edge 1.3 in the direction of the conductor track. At the second end 1.7, the flat conductor connection element 1 has the second connection region 1.8.

FIG. 5 shows a schematic plan view of the flat conductor connection element 1 according to the invention with recesses 4.2. The recesses 4.2 have different shapes. The recesses 4.2 have a rectangular, arcuate, or triangular shape. The recesses 4.2 are located in the region of the outer edge 1.3 of the cover film 1.2. They are in the edge region of the cover film 1.2, in which the cover film 1.2 is glued to the cover film 1.2 of the opposite side at the protruding edges. The recesses 4.2 are open to the outer edge. Each recess 4.2 acts as a sealant 4. The flat conductor connection element 1 can be used with a pane 102 having an electrical component 6.

FIG. 6 shows a cross-sectional view of a connection arrangement 104 according to the invention. The connection arrangement 104 comprises a glazing unit 100 with an electrical component 6—in particular, a so-called PDLC functional element—and a flat conductor connection element 1 according to the invention.

The glazing unit 100 is formed as a composite pane. In this case, the composite pane is designed as a roof pane of a motor vehicle. The glazing unit 100 comprises a first pane 101 and a second pane 102. In the installed position, the first pane 101 serves as an outer pane and the second pane 102 as an inner pane. In this case, the inner pane is the pane directed towards the vehicle interior, while the outer pane points towards the vehicle environment. The surface of the outer pane that faces the vehicle environment is referred to as surface I, as is usual in vehicle glazing technology, and the surface of the inner pane that faces the vehicle interior is referred to as surface IV. The two panes 101 and 102 consist, for example, of soda-lime glass. The two panes 101 and 102 are fixedly connected to one another by two, thermoplastic intermediate layers 103—for example, made of polyvinyl butyral (PVB), ethylene vinyl acetate (EVA), or polyurethane (PU).

The glazing unit 100 is provided with an electrical functional element 6 located between the two panes 101 and 102. The electrical functional element 6 may, for example, be a PDLC functional element which serves, for example, as an electrically-controllable sun or sight protection. The PDLC functional element is formed by a commercially available PDLC multilayer film which is embedded in the intermediate layer 103. For this purpose, the intermediate layer 103 comprises, for example, a total of three thermoplastic films (not shown) having a thickness of 0.38 mm, for example, of PVB, wherein a first thermoplastic film is connected to the first pane 101, and a second thermoplastic film is connected to the second pane 102. The PDLC functional element generally comprises an active layer between two planar electrodes and two carrier films. The active layer contains a polymer matrix with liquid crystals which are dispersed therein and which align as a function of the electrical voltage applied to the planar electrodes, whereby the optical properties can be controlled. The planar electrodes can be electrically contacted via busbars. The flat conductor connection element 1 is used to apply a voltage to the busbars of the functional element 6.

The connection arrangement 104 furthermore has the flat conductor connection element 1. The busbars of the functional element 6 are electrically-conductively connected to the flat conductor connection element 1. A reliable electrically-conductive connection is preferably achieved by soldering the connection 5.

It is understood that the flat conductor connection element 1 can be adapted to the respective conditions of the actual use and can extend, for example, over two, three, or four planes. Alternatively or in combination, more or fewer conductor tracks per plane can be arranged next to one another.

The flat conductor connection element 1 is partially laminated with its first end 1.4 into the glazing unit 100 and guided between the two panes 101 and 102 out of the composite pane 2 in the exit region 18. The first end 1.4 has the sealant 4 formed as an adhesive tape 4.1. The flat conductor connection element 1 is guided around a side surface of the first pane 101 and is arranged on the surface IV of the first pane 101. For this purpose, the first pane 101 can have a recess, e.g., through a ground region (not shown here), in the exit region 18.

FIGS. 7A and 7B show an embodiment of the connection arrangement 104 according to the invention, in which the adhesive tape 4.1 projects beyond the outer edge 1.3 of the flat conductor connection element 1. The adhesive tape 4.1 is wider than the flat conductor connection element 1. The flat conductor connection element 1 is partially laminated with its first end 1.4 into the glazing unit 100 and is guided out of the glazing unit 100 in the exit region 18. FIG. 7A shows a plan view of the connection arrangement 104. FIG. 7B shows a cross-sectional representation (A-A′) of the glazing unit 100 of FIG. 7A. The adhesive tape 4.1 can be arranged on only one side of the flat conductor connection element 1 or be located on the two opposite sides of the flat conductor connection element 1, as shown in FIG. 7B.

FIGS. 8A and 8B show a further embodiment of the connection arrangement 104 according to the invention, in which the flat conductor connection element 1 has two recesses 4.2. The adhesive tape 4.1 is narrower than the flat conductor connection element 1. The flat conductor connection element 1 is partially laminated with its first end 1.4 into the glazing unit 100 and is guided out of the glazing unit 100 in the exit region 18. FIG. 8B shows a cross-sectional representation (A″-A″) of the glazing unit 100 of FIG. 8A. The adhesive tape 4.1 can be arranged on only one side of the flat conductor connection element 1 or be located on the two opposite sides of the flat conductor connection element 1, as shown in FIG. 8B.

The recesses 4.2 have a rectangular shape. The recesses 4.2 are located in the region of the outer edge 1.3 of the cover film 1.2 at two opposite edges. They are in the edge region of the cover film 1.2, in which the cover film 1.2 is glued to the cover film 1.2 of the opposite side at the protruding edges. Each of the two recesses 4.2 reduces the width of the flat conductor connection element 1. The recesses 4.2 are open to the outer edge 1.3. The recesses 4.2 are at least partially covered by the adhesive tape 4.1. They are at least partially filled with the adhesive layer of the adhesive tape 4.1, the adhesive tape 4.1, and/or the intermediate layer 3 so that the ingress of water into the glazing unit 100 by capillary action along the outer edge 1.3 of the flat conductor connection element 1 is prevented.

### LIST OF REFERENCE SIGNS

1 Flat conductor connection element
1.1 Conductor track
1.2 Cover film
1.3 Outer edge
1.4 First end
1.5 First connection region
1.6
1.7 Second end
1.8 Second connection region
1.9
2 Cable
2.1 Conductor of the cable
2.2 Cable jacket
4 Sealant
4.1 Adhesive tape
4.2 Recess
5 Soldered connection
6 Functional element
10 Line connection
11 Cross-sectional transition region
12 Encapsulation
17 Socket or plug
18 Exit region
100 Glazing unit
101 First pane (substrate)
102 Second pane
103 Intermediate layer
105 Connection arrangement
1 First surface (outer side) of the first pane 101
IV Second surface (inner side) of the second pane 102
R Lateral edge of the adhesive tape 4.1
B Edge region of the adhesive tape 4.1

1. A connection arrangement comprising a glazing unit with an electrical component and a flat conductor connection element, which comprises at least one electrical conductor track and a cover film for electrically insulating the conductor track,
wherein the flat conductor connection element has a first connection region at a first end, a second connection region at a second end,
wherein the first connection region is arranged between two panes of the glazing unit, and wherein the flat conductor connection element is guided with the second connection region between the two panes out of the glazing unit,
wherein the electrical conductor track of the flat conductor connection element is provided for electrically contacting the electrical component,
wherein a sealant is arranged at the first end and/or at the second end of the flat conductor connection element, and
wherein the flat conductor connection element has at least one recess in the region of an outer edge, and the recess is filled with an adhesive layer, an adhesive tape, or a thermoplastic layer.

2. The connection arrangement according to claim 1, wherein the sealant of the flat conductor connection element is provided for blocking water capillaries.

3. The connection arrangement according to claim 1, wherein the sealant is an adhesive tape.

4. The connection arrangement according to claim 1, wherein the sealant is formed as a double-sided adhesive tape.

5. The connection arrangement according to claim 3, wherein the adhesive tape is arranged on two opposite sides of the flat conductor connection element.

6. The connection arrangement according to claim 3, wherein the adhesive tape is connected planarly to the cover film via an adhesive layer.

7. The connection arrangement according to claim 3, wherein the adhesive tape projects beyond an outer edge of the flat conductor connection element.

8. The connection arrangement according to claim 3, wherein the adhesive tape has, at least in portions, an edge region which is located between a lateral edge of the adhesive tape at a distance perpendicular to an outer edge.

9. The connection arrangement according to claim 1, wherein the flat conductor connection element has at least one recess in the region of an outer edge, wherein the recess is open to the outer edge.

10. The connection arrangement according to claim 9, wherein the recess tapers from the outer edge in the direction of the conductor track.

11. The connection arrangement according to claim 1, wherein the flat conductor connection element has at least one recess, which is arcuate or rectangular, in the region of an outer edge.

12. The connection arrangement according to claim 1, wherein the recess is filled with an adhesive layer and an adhesive tape.

13. The connection arrangement according to claim 1, wherein the electrical component is a functional element.

14. The connection arrangement according to claim 13, wherein the functional element is a PDLC functional element.

15. An electrical line connection with a cross-sectional transition region from the flat conductor connection element, comprising the conductor track, of the connection arrangement according to claim 1 to a cable comprising at least one electrical conductor, wherein an electrical connection between the conductor track of the flat conductor connection element and the conductor of the cable is provided in the cross-sectional transition region, and wherein the cross-sectional transition region has an encapsulation as a plastic component for electrical insulation.

16. The connection arrangement according to claim 9, wherein the at least one recess is within the cover film.

17. The electrical line connection according to claim 15, wherein the cable is a round cable.
